(19) United States
(12) Patent Application Publication
(10) Pub. No.: US 2015/0312447 A1
(43) Pub. Date: Oct. 29, 2015

(54) VISUAL IMAGE DEVICE AND METHOD

(71) Applicant: Ahmed OMAR, Toronto (CA)

(72) Inventor: Ahmed OMAR, Toronto (CA)

(21) Appl. No.: 14/695,666

(22) Filed: Apr. 24, 2015

Related U.S. Application Data
(60) Provisional application No. 61/984,218, filed on Apr. 25, 2014.

(51) Int. Cl. H04N 5/225; H04N 7/18; A63F 13/285; G06T 7/00; A63F 13/213; H04N 5/77; G06F 3/01

(52) U.S. Cl. CPC H04N 5/2251; H04N 5/77; H04N 7/18; G06F 3/016; G06F 3/011; G06T 7/0061; A63F 13/213; A63F 13/285; G06F 2203/015; G06F 2203/013; G06F 2211/005

(57) ABSTRACT

A system for providing an alternate method of video game control comprising a visual imaging device attached to an apparatus of some sort to then be worn, held, or connected in some way to a living body, a computer processing unit connected to the visual imaging device, a video game console controller connected to the computer processing unit, multiple motors attached to the apparatus that is meant to be worn, held or attached to a living body, which are connected to the computer processing unit; and a method of providing directional input to a user including the steps of capturing a reference image having at least one reference point, storing the captured image and reference point in a data base, sequentially capturing subsequent moving images each having at least one reference point, storing the sequentially subsequent moving images and at least one reference points in a data base, calculating variations between the at least one reference point from the reference from the reference image and subsequent moving images to generate a signal representing movement of the reference points.

### CROSS-REFERENCE TO RELATED APPLICATION

This application claims priority from U.S. provisional patent application No. 61/984218, entitled “Visual Image Device and Method”, filed Apr. 25, 2014, the entire contents of which is incorporated herein by reference.

### FIELD

This disclosure relates generally to visual image processing and the applications of a visual image processing system and more particularly to a method of camera assisted control for console based video game systems and assistance in daily activities. In one embodiment the disclosure relates to a system and method of video game control which makes use of a camera in order to simulate directional input of a touch stick on a video game controller as an alternative during game play.

In another embodiment the disclosure relates to a system and method for assisting a visually impaired individual that utilizes a mobile device to enable a visually impaired individual.

### BACKGROUND

Most console-based gaming systems are controlled via a separate apparatus that provides different commands to the system. This can most commonly be seen in the most popular consoles currently on the market today. The majority of television display console-based gaming systems receive input from a controller with one or more touch sticks, one or more trigger buttons, one or more direction pad inputs, and one or more miscellaneous buttons. This is a very popular configuration with one touch stick controlling directional input controlling the character, while the second touch stick is used to control some other aspect of the game. In a large portion of popular video games, the second touch stick is used to control the field of view on screen. This can be most clearly seen in a large portion of first and third person video games. These types of games can also be found on personal computing devices such as desktop computers or laptops. On these alternative systems, unless the use of a controller is explicitly desired by the end user, the mouse is the default controller of the field of view of the player. The implementation of the mouse as the control for the field of view of the player controlled character provides a fluid motion to easily rotate and accurately target specific areas or other players. However, television displayed console-based gaming systems are unable to benefit from a mouse as it will make it exceptionally difficult as most of the action buttons are on the controller and cannot be rebound to the mouse.

Unfortunately, the touch stick as a method of control for field of view is often either overtly sensitive or not sensitive, limiting the speed at which the players are capable of turning around in order to react to other hostile players that may be controlled by the scenario of the situation or by other players. Another limitation is that the method of using either a mouse or a touch stick separates the player from the experience instead of immersing the player in it. By causing the player controlled character to almost mimic the actions of the player, the goal is to provide a better user experience. Finally, the time necessary to turn and scan an area for hostile targets is significantly slower when using a touch stick than when using a mouse allowing non-console players to react more quickly.

Furthermore visual impairment and compromised vision can be the result of many sources, for example, disease, genetic abnormalities, injuries, or age. Visually impaired individuals often use auditory feedback methods and more commonly, guide dogs or the conventional white cane for navigating movement within small confines as well as open and unfamiliar areas. Existing electronic technologies often rely purely on visual cues or communication wirelessly with another device. This limits the visually impaired individual to areas where wireless signals can be sent and received, unfortunately, many areas, primarily public transportation including but not limited to subways and buses, that provide easy access to different areas, often limit the wireless signal that can be broad-casted. Additionally, constant wireless transmission may incur large data access fees.

### SUMMARY

The present technology provides in one embodiment an alternative method for television displayed console-based gaming system players to control the field of view of the player-controlled characters in video games. The video game may be of multiple genres including but not limited to, shooters, action, and action-adventure. Additionally, these games may or may not incorporate a first or third person view.

In a preferred embodiment, a camera is used in place a touch stick on a video game, wherein the camera provides absolute or relative position information to a processor.

In one embodiment, a method for providing directional input to a video game is provided. The method initiates with capturing an image of the visual display. Key points of the display are saved as reference and then as the camera is moved the two values are compared to each other to determine the direction that the camera is turning. The variance between the new key points and the reference key point is then after additional processing, is then used as input into the video game controller.

In one embodiment, the method includes applying input direction to one or more of the following: controlling the trolling the direction of a virtual object within the video game, and determining a target direction.

In an embodiment, the method includes repeating the capturing of the image and the determining of the variance between the new key points captured on this iteration, and the reference key points captured at the initialization step.

In another embodiment, the camera is connected to a processor which is then connected a video game controller, the game controller is optimized for receiving input from the camera and processor instead of a touch stick.

In yet another embodiment, the camera is positioned in a region on the player that allows the camera's field of view to encapsulate the entire visual display that the console-based gaming system is being displayed upon. In an exemplary embodiment, the camera is mounted on the head of the player, however, it can also be placed on the shoulders or chest or any area on the body that would allow the camera to capture the entire visual display and in a position that is capable of various angles of movement.

In one embodiment, the variance between the reference points and the newly captured points must exceed a configurable value to allow for various sensitivities.

In an additional embodiment, there may be motors attached to the apparatus that will vibrate due to in-game events that may or may not prompt the user to move in a way that, in the exemplary embodiment, causes the player-controlled character to move in the same manner as to focus more clearly on the in-game event.

In yet another embodiment, the motors that are attached to the headband apparatus can be used to vibrate in response to other events, such as those registered visually by the camera attached to the top of the apparatus. In an exemplary embodiment, the magnitude of the vibration of the motors may increase or decrease due to a perceived severity of either an in-game event or an event registered visually by the camera. Examples of events registered visually by the camera include, but are not limited to: proximity to an object within the field of view of the camera, as well as shape recognition.

In an additional embodiment there may be motors attached to the apparatus that will vibrate due to in game events that may or may not prompt the user to move in a way that causes the player controlled character to move in the same manner as to focus more clearly on the in-game event.

In a further application of the invention an alternative method for assisting visually impaired individuals is disclosed as they go about doing their day to day activities. These day to day activities include but are not limited to, doctor's appointments, buying groceries, and other activities that may cause the visually impaired user to be in constantly changing environments.

In a preferred embodiment, a camera and a depth sensor is attached to a band to create a head-mounted device, wherein the camera provides visual image data while a depth sensor provides distances to the individual images.

In one embodiment, the head-mounted device may also have multiple vibrating motors in order to provide tactile feedback. In another embodiment, one or more of the motors may vibrate in a pre-determined sequence, set as default, or preset by the user, in order to direct the individual as well as to signify obstacles that may be in the individual's way, such obstacles may be but are not limited to telephone poles, curbs, other persons with that may or may not have a relationship with the visually impaired individual. In yet another embodiment the motors may span across multiple rows of the head-mounted device.

In one embodiment, the method includes repeatedly capturing the image and determining the variance between the new key points captured on this iteration and the reference key points.

In another embodiment, the camera and depth sensor are connected to a computing device with a processor, which is then connected to the multiple motors within the head-mounted device. The computing device can be capable of many alternative functions beyond just processing. The device may be capable but is not limited to wireless communication and as a global positioning system.

It is an aspect of this invention to provide a method of providing directional input to a user including the steps of: capturing a reference image having at least one reference point; storing the captured image and reference point in a data base; sequentially capturing subsequent moving images each having at least one reference point ; storing the sequentially subsequent moving images and at least one reference points in a data base; calculating variations between the at least one reference point from the reference from the reference image and subsequent moving images to generate a signal representing movement of the reference points,

It is another aspect of the invention to provide a system of providing directional input comprising: a camera for storing at least one reference point in an image; a database for storing a plurality of images and at least one reference point associated with the plurality of images; a processor for calculating variations between the at least one reference point in the plurality of images to generate a signal representing movement of the reference points.

It is yet another aspect of the invention to provide a system for assisting a visually impaired individual; the system comprising: a visual imaging device for capturing visual data; relaying the captured visual data from the visual imaging device to a computer processing unit; the computer performing an analysis of the visual information, and generating a signal to represent a specified event if it occurs, the signal communicating with one or more of the motors.

These and other objects, features, advantages and alternative aspects of the present invention will become apparent to those skilled in the art from a consideration of the following detailed description taken in combination with the accompanying drawings.

### BRIEF DESCRIPTION OF THE DRAWINGS

FIG. 1 is a block diagram of the image processing unit and the various connections that are required for functionality using an exemplary controller.

FIG. 2 is back, top and right side perspective view of a video game controller that is used for the Xbox® 360 game console, showing the two touch sticks.

FIG. 3 is a block diagram of the components of an exemplary alternative method of control which provide the functionality in accordance with the principles of the present embodiment.

FIG. 4 is a block diagram illustrating an exemplary method of capturing and processing an image from a camera to calculate the direction.

FIG. 5 is two views of the head-mounted device with the processing unit attached.

FIG. 6 is a diagram depicting an exemplary user using it with an exemplary console system in an exemplary environment.

FIG. 7 is a block diagram illustrating another exemplary method for capturing and processing the image from the camera to calculate the direction, according to an exemplary embodiment.

FIG. 8 is a diagram depicting an exemplary scenario where the visually impaired individual encounters a larger object, in this case, a person.

FIG. 9 is a diagram depicting an exemplary scenario where the visually impaired individual approaches a curb.

FIG. 10 is a diagram depicting an exemplary scenario where the visually impaired individual encounters a smaller object that is capable of inconveniencing or impeding movement of the visually impaired individual.

### DETAILED DESCRIPTION

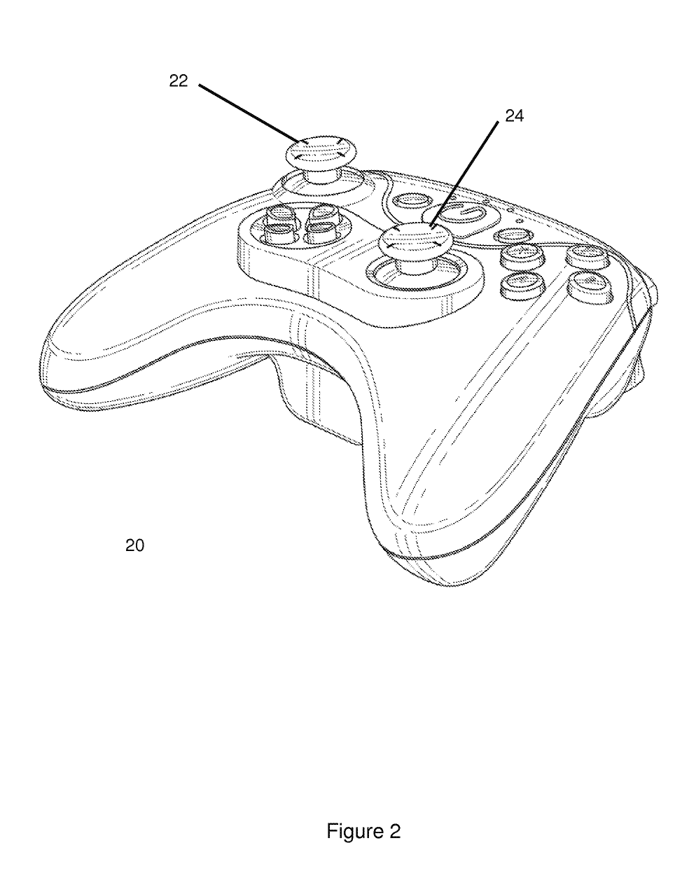

FIG. 2 is a perspective view of an Xbox® 360 game controller 20 that is used with the Xbox® 360 game console (not shown). The device shown is wireless but the device can also be wired and should not be limited to a wired or wireless implementation. It is to be understood that this embodiment is not limited to only this game controller or this game console. Any device or application including a game controller that uses a touch stick as input can be replaced by the present invention in order to provide a new interface.

This particular game controller 20 includes two touch stick 22, 24 as well as other controls that are not important to the current implementation. In this first embodiment, the two touch sticks 22, 24 are not modified in any way whatsoever. The touch stick 22 is, by default, primarily used to control character movement, however the other touch stick 24 is, in the default configuration, is used to control the field of view or perspective of the character in a first or third person environment.

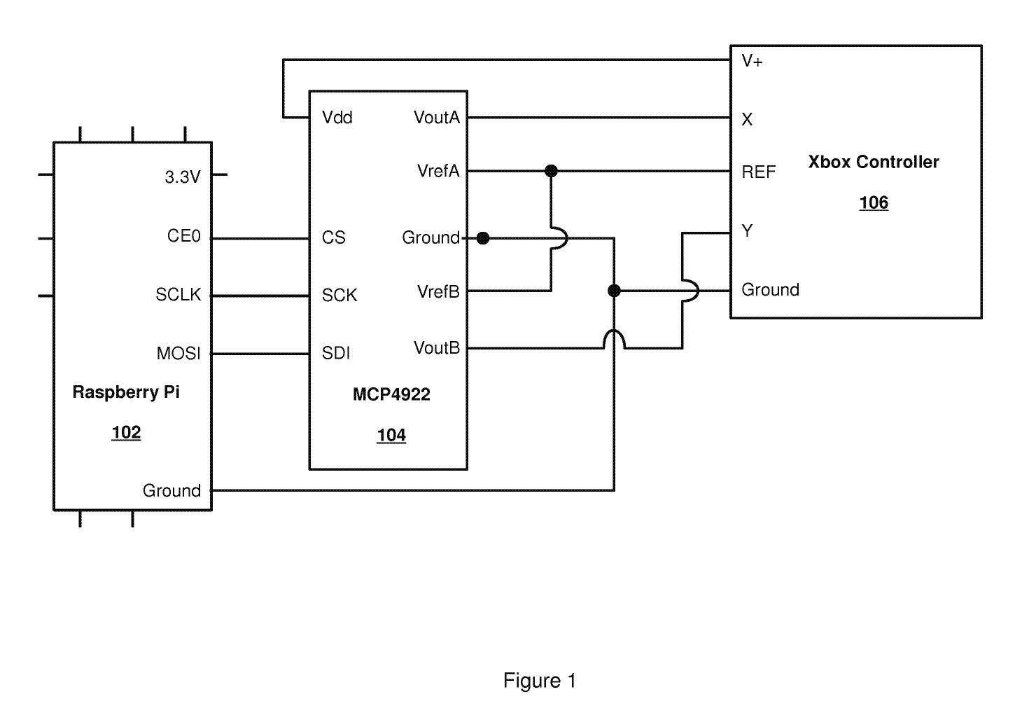

FIG. 1 is a block diagram denoting the various connections amongst the different components. A key component that is not shown in the diagram is the presence of a camera connected via a universal serial bus (USB) which is attached to the processing unit, the Raspberry Pi 102, a single-board computer that is commercially available from the Raspberry Pi Foundation in the United Kingdom, The camera is directly connected to the Raspberry Pi 102 which is running Raspbian, a free, Debian-based operating system which is optimized for the Raspberry Pi 102 hardware. The Raspberry Pi 102 is then connected to the MCP4922 104, a digital to analog converter. The connection between the Raspberry Pi 102 and MCP4922 104 is handled through the general-purpose input/output pins on the Raspberry Pi 102. There are three serial peripheral interface (SPI) output pins and they connect to the three SPI input pins on MCP4922 104. The three SPI output pins on the Raspberry Pi 104 are Serial Clock (SCLK), Master out Slave in (MOSI) and CEO pin. These generate the SPI digital signal that the MCP4922 104 converts to an analog signal that is fed into the various inputs of the Xbox® 360 controller.

The SPI digital signal is a 12 bit binary digital signal which is used to configure the MCP4922 104 and to transfer the value that of the analog signal that will be passed. The four most significant bits (MSB) are used to configure the MCP4922 104. The MSB is used as a selector bit, it decides whether VoutA or VoutB is where the signal will be sent. In this embodiment, a zero would select VoutA and a one would select VoutB. The second MSB is ignored as its value does not affect configuration. The third MSB controls voltage gain of the output. If the third MSB is a one, there is no gain. However, if it is a zero, the voltage output through one of the output pins is doubled. The fourth MSB of the configuration controls whether the MCP4922 104 is turned on or off. A zero would ensure that the converter is off, while a one would cause the converter to be turned on. The eight least significant bits (LSB) are binary bits to represent a decimal number between zero and 255. VoutA on the MCP4922 104 controls horizontal direction voltage input of the touch stick on the Xbox® 360 controller. If the value of VoutA is equivalent to 0.8 volts then there is no movement. If, however, the value of VoutA is less than 0.8 volts, the response would be as if the player wished to move the perspective of the player-controlled character to the left. On the contrary, if the value is greater than 0.8 volts, then the perspective of the player-controlled is moved towards the right. VoutB controls the vertical direction voltage input of the touch stick on the Xbox® 360 controller. The voltage markers for VoutA are similar for VoutB. If the voltage is 0.8 volts, there is no vertical movement. If the voltage is less than 0.8 volts, then the field of view of the player-controlled character moves downward, and conversely, if it is greater than 0.8 volts, it moves upwards. Finally, the final constraint for both VoutA and VoutB is that there is a maximum and a minimum voltage, the maximum voltage is 1.3 volts, while the minimum voltage is 0.3 volts.

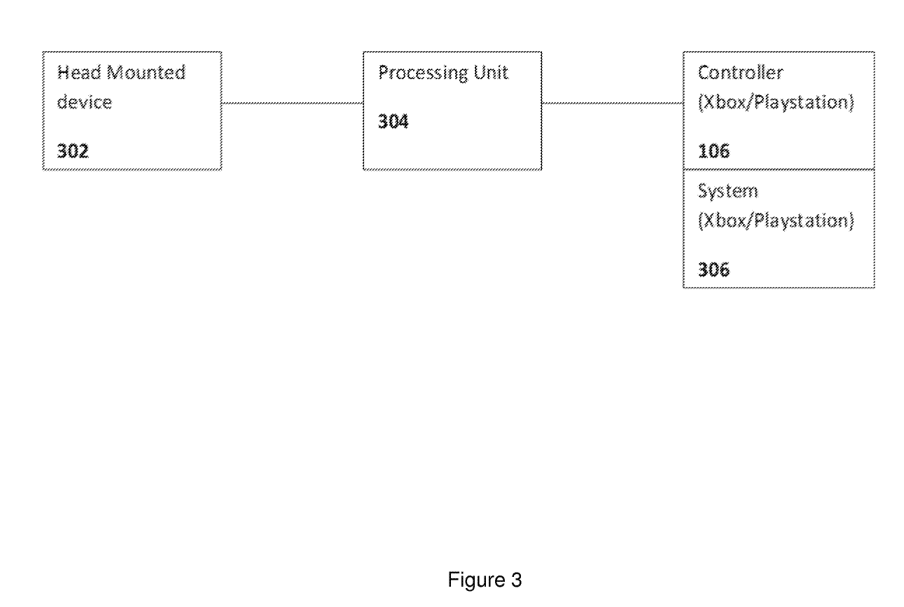

FIG. 3 is a block diagram denoting the major components within the present embodiment. It is important that while it is labeled as a head mounted device 302, the device does not need to be mounted on the head and can in fact be mounted anywhere with the head of the user being recommended.

A user operates the head mounted device 302, which is used to provide directional input to the video game. The head mounted device 302 is configured to capture an initial frame, which it passes to the Raspberry Pi 102 for processing. From this initial frame, the Raspberry Pi 102 is now capable of generating, using canny edge detection, a rectangle of variable height and width capable of encapsulating the entire visual display, and from it, the x and y co-ordinates of the centre point of the display can be calculated. After this initialization step, the camera on the head mounted device 302 continuously captures frames and passes them to the processing unit 302. From these frames, the value of the centre point of the rectangle encapsulating the display is continuously calculated and compared to the reference value. If the x component of a newly captured frame varies from the references x value by a configurable amount then that indicates that there is lateral movement, that the user has moved in a way that has caused the new rectangle to be either left or right of the initial reference rectangle. The same is done for the y component of the newly captured frame, except it is used to denote whether the frame is above or below the initial reference rectangle. The centre point of the rectangle is used over the corners or the midpoint of edges as this will allow the user to move closer or further away from the screen without causing the unit to believe that the user had rotated their head in some fashion.

This processing stage then goes on to set the configuration of the MCP4922 104. It does so by writing three four-bit characters to the output pins of the Raspberry Pi 102 which are then fed into the MCP4922 104.

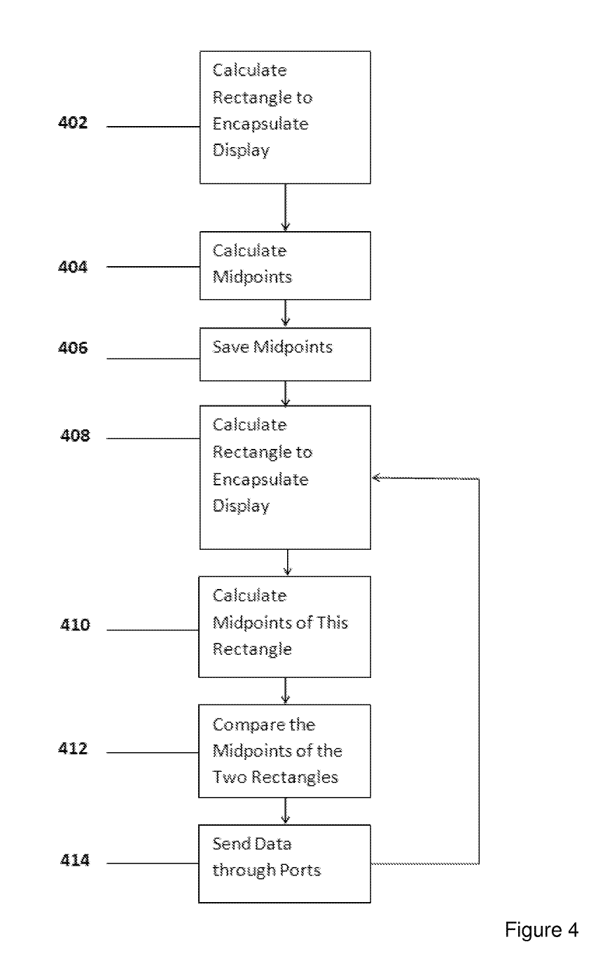

FIG. 4 is a block diagram illustrating an exemplary method for capturing and processing the image from the camera and calculating the direction, according to an exemplary embodiment. At the first step 402, the camera is initialized and calculates the rectangle required to encapsulate the visual display. From this, it moves on towards the second step, 404, calculating the middle point (x,y) of the rectangle. Upon calculating the proper points, these points are saved in a following stage 406. The next step 408, is similar to the first step 402, as it continuously calculates the rectangle required to encapsulate the display. It then in step 410 calculates the midpoints of this rectangle, however these midpoints are not saved and are in fact, in step 412 compared to the initially saved midpoints. This allows the Raspberry Pi 102 to see if there is any variance between the initial rectangle midpoints and subsequently captured midpoints to determine the direction that the user has moved in order to generate the same response on the player-controlled character within the video game. Finally, in step 414, the data is sent through the various general purpose input/output ports of the Raspberry Pi 102 to the digital-to-analog convert, MCP4922 104 in the manner described above.

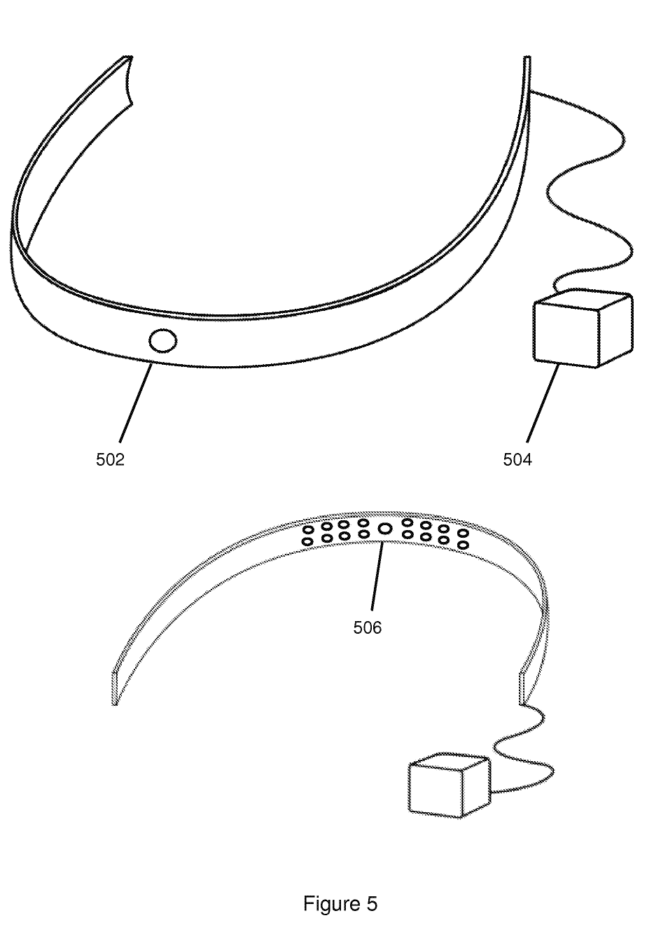

FIG. 5 depicts multiple views of a head-mounted device. The visual imaging device 502 is mounted at the front of the device. The field of view of the visual imaging device should be wide enough to encapsulate a display. The processing unit 504 composed of the central processing unit 102 and the digital-to-analog converter 104 is encased and plugged into the base of the video game controller 106. The head-mounted device 302 has motors 506 embedded into the entire head-mounted device to provide feedback from the direction encapsulated by the field of view of the visual imaging device 502.

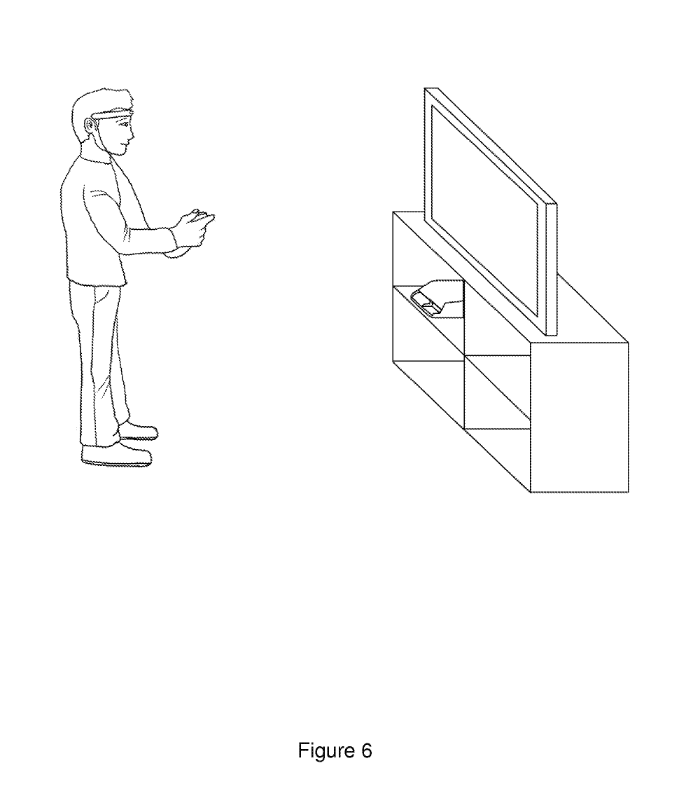

FIG. 6 depicts an exemplary user using the device in an exemplary environment in order to play a video game of genre described above. The head-mounted device 302 can be seen worn on the users head with the video game controller 106 held in the users hands. The visual imaging device 502 of the head-mounted device 302 is pointed at the display.

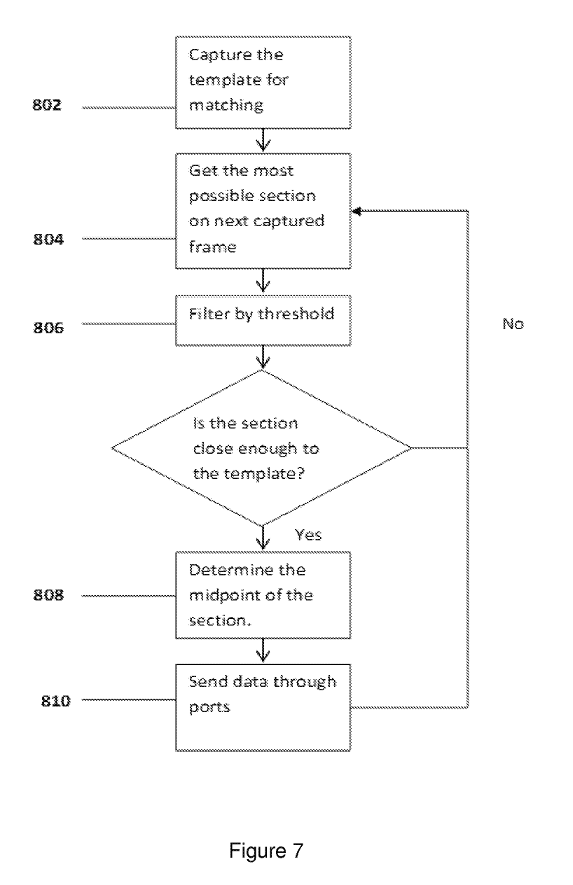

FIG. 7 is a block diagram illustrating an exemplary method for capturing and processing the image from the camera and calculating the direction, according to an exemplary embodiment, At the first step 802, the camera is initialized and capture template for comparing purpose. From this, it moves on towards the second step, 804, calculating the most possible position the template may lay on the frame, once this is done, the result value will be send to 806, a filter will be use the filter out the result if the value is under a certain threshold. If it was an unreasonable result, the program will roll back to 804 and re-calculate a possible position for the template on the next frame. If the result is reasonable, it will toward to 808, the section's midpoint will be determined. And this will be compared to the initially saved midpoints. This allows the central processing unit 102 to see if there is any variance between the initial template midpoints and subsequently captured midpoints to determine the direction that the user has moved in order to generate the same response on the player-controlled character within the video game. Finally, in step 810, the data is sent through the various general purpose input/output ports of the central processing unit 102 to the digital-to-analog converter 104 in the manner described above.

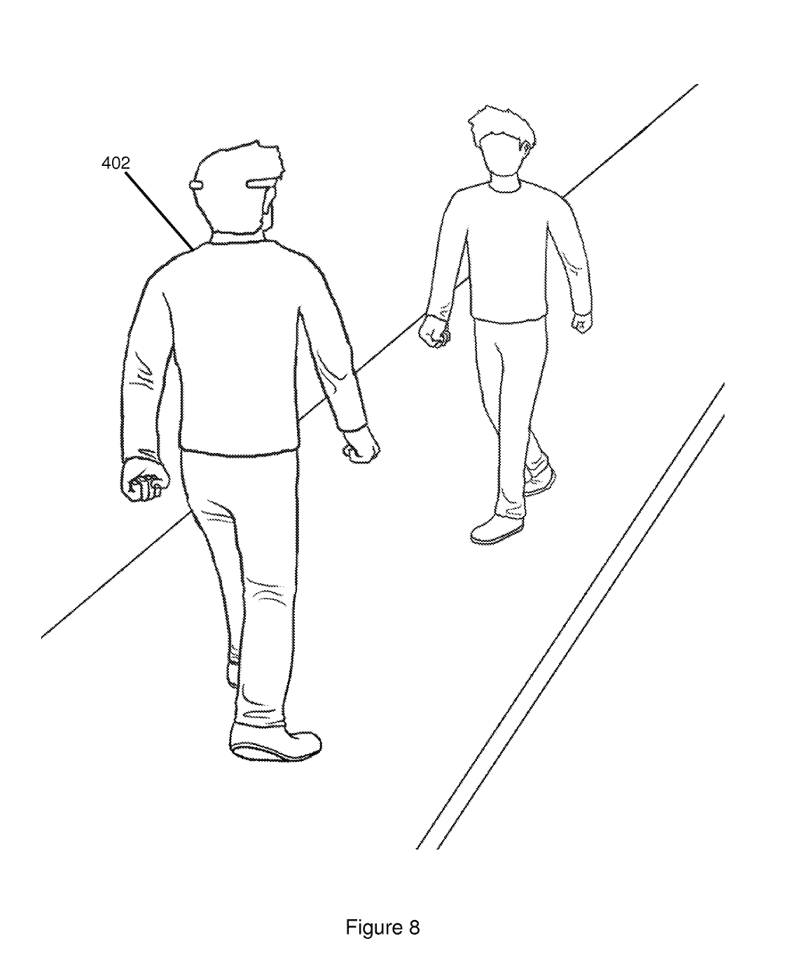

In FIG. 8, an exemplary scenario where a visually impaired user 402 encounters a large obstacle that inconveniences, impedes movement and may cause injury to the visually impaired user 402 as well as inconvenience or impede the movement of other individuals, In FIG. 4, the obstacle is another individual, however, it can include but is not limited to, tree, telephone pole, street light, and animals. A motor 506, may vibrate to signal in a pre-determined pattern previously taught to the visually impaired individual 402 that may be decided by said user or by the manufacturer of the product, For example, the top most motor closest to the object in question may vibrate to signal the presence of this obstacle.

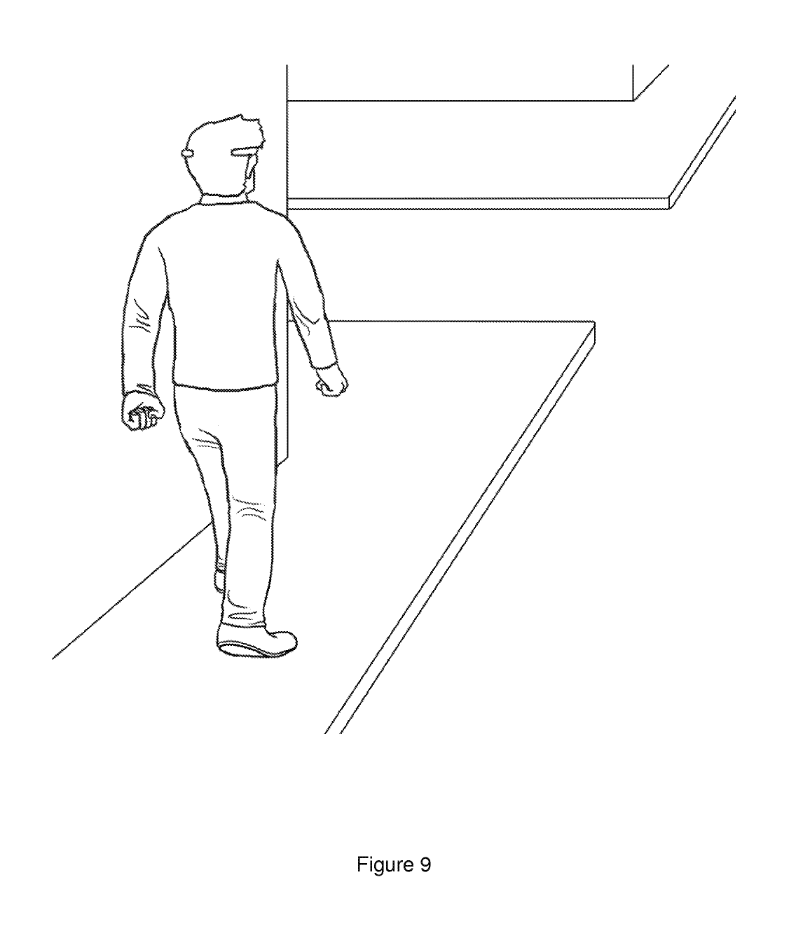

In FIG. 9, another exemplary scenario is depicted where a visually impaired user 402 encounters a curb or step which may cause the visually impaired individual 402 to fall, or stumble resulting in either injury, or a dangerous situation. A majority of motors 506 may signal in a pre-determined pattern taught to the visually impaired individual 402 that may be decided by said user or by the manufacturer. For example, the top row of motors and then the bottom most motors may vibrate in sequence in order to signal a step down, however any combination is possible as long as the user can recognize the sequence to signify that a step up or step down is required to traverse the obstacle.

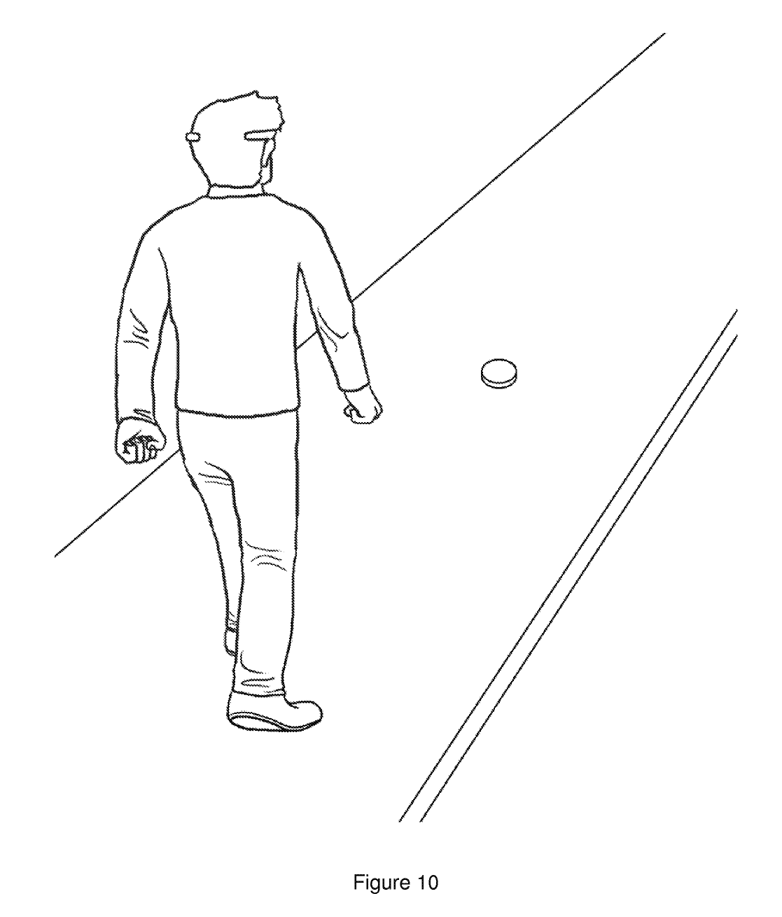

In FIG. 10, an additional exemplary scenario is depicted where a visually impaired individual 402 encounters a small object which may impede or inconvenience the movement of the user which can be traversed by manoeuvring around the obstacle in general. Similar to previous scenarios, a motor 506 may signal in a pre-determined pattern taught to the visually impaired individual 402. For example, the bottom most motor closest to the obstacle in question may vibrate to signal the presence of the obstacle in question.

The invention described herein has applicability to visually impaired individuals; and in particular for a visually impaired individual encountering an obstacle. An example of situation with an obstacle would be crossing an unfamiliar intersection. It should be noted, however, that the situation and the obstacle may be any hindrance or impediment that interferes, restricts or prevents action by the visually impaired individual and should not be limited in any way by the example given above.

A long white cane, the international symbol of blindness, is employed by the visually impaired individual to extend the range of touch sensation of the individual. By swinging the cane in a low sweeping motion across the intended path of travel, the long white cane enables the visually impaired individual to detect obstacles. It should be noted that although a long white cane is used in the example, the visually impaired individual may employ other adaptive technologies, such as a lighter identification cane, support cane, or guide dog, for example, to assist in navigation.

The long white cane is an insufficient adaptive technology for the visually impaired individual to negotiate or navigate the obstacle described above. Other obstacles that may be encountered include curbs, single obstacles such as telephone poles or other singular obstacles as well as other obstacles such as a wall or other wider obstacles.

In the first embodiment, the vibrating motors span multiple rows, preferably two however it should not be limited to such and more rows of motors is possible. In order to traverse a singular obstacle such as a tree, another individual or a telephone pole for example, the motor along the lowest row closest to the object will vibrate to signal that there is an obstacle in that direction with the intensity of the vibration increasing dependent on proximity. For other obstacles such as a step or a curb, the vibration pattern of the motors will vary depending on if the user must step up or step down. If the user must step up, then the entire bottom row of motors will vibrate, followed by the top row of motors while the opposite is true if the user must step down a curb or step. Other vibration patterns can also be programmed into the processing unit, for example, in order to denote that the individual should stop, all the motors along all the rows will vibrate together.

A secondary function of the computing device is to act as a global positioning system and it will be capable of providing direction for the user as they go about their activities. In order to signify turns, the top most row of motors will vibrate in sequence, starting from the centre and then in the direction that the user should turn.

We claim:

1. A system for providing an alternate method of video game control comprising of:
a. a visual imaging device attached to an apparatus of some sort to then be worn, held, or connected in some way to a living body,
b. a computer processing unit connected to the visual imaging device,
c. a video game console controller connected to the computer processing unit,
d. multiple motors attached to the apparatus that is meant to be worn, held or attached to a living body, which are connected to the computer processing unit.

2. The system, as recited in claim 1, wherein said video game console controller has two analog joysticks.

3. The system, as recited in claim 1, wherein the data captured by the visual imaging device are used as input to the computer processing unit.

4. The system, as recited in claim 3, wherein the computer processing unit processes the image data.

5. The system, as recited in claim 4, wherein the computer processing unit, upon completion of the image processing, provides signals which are used as input into the video game controller.

6. The system, as recited in claim 5, wherein the signals from the computer processing unit override the default input of one of the two analog joysticks of the video game controller.

7. The system, as recited in claim 1, wherein events registered by the computer processing unit are comprising of:
a. an in-game event,
b. a visual image processing event preset by the programmer or user of the system.

8. The system, as recited in claim 7, wherein the events may illicit a response in one or more of the motors attached to the apparatus.

9. A system for assisting a visually impaired individual, the system comprising:
a. encountering a situation with an obstacle,
b. capturing visual data at the visual imaging device attached to the apparatus,
c. relaying the captured visual data from the visual imaging device to a computer processing unit connected to the computer processing unit,
d. performing an analysis of the visual information, and registering an event if it occurs,
e. relaying signals to one or more of the motors.

10. The system, as recited in claim 9, further comprising:
a. transmitting substantially continuous, real-time visual feed from the visual imaging device to the computer processing unit,
b. transmitting continuous analog or digital signals to one or more motors.

11. The system, as recited in claim 10, wherein the computer processing unit processes the image data.

12. The system, as recited in claim 9, wherein the events registered by the computing processing unit are events preset by the user or an alternate developer.

13. A method of providing directional input to a user including the steps of:
a) capturing a reference image having at least one reference point;
b) storing the captured image and reference point in a data base;
c) sequentially capturing subsequent moving images each having at least one reference point;
d) storing the sequentially subsequent moving images and at least one reference points in a data base;
e) calculating variations between the at least one reference point from the reference from the reference image and subsequent moving images to generate a signal representing movement of the reference points.

14. A method as claimed in claim 13 wherein at least two reference points are captured in the image.

15. A method as claimed in claim 13 wherein a camera mounted on a head band of a user captures the reference image.

16. A method as claimed in claim 15 further mounting vibrating motors to the head band for vibrating in response to the signal.

17. A method as claimed in claim 15 providing a depth sensor for sensing distance between the user and the reference image.

18. A method as claimed in claim 17 further including a plurality of vibrating motors to provide a tactile feed back.
